(19) United States
(12) Patent Application Publication
(10) Pub. No.: US 2024/0062309 A1
(43) Pub. Date: Feb. 22, 2024

(54) DELIVERY OF CUSTOMIZED INSURANCE PRODUCTS AND SERVICES

(71) Applicant: Allstate Insurance Company, Northbrook, IL (US)

(72) Inventors: Floyd M. Yager, Park Ridge, IL (US); THOMAS J. Wilson, Chicago, IL (US); Pablo Azar, Winnetka, IL (US); Edward A. Biemer, Eastbourne (GB); Jeremy Frank, Chicago, IL (US); Mark David Pitchford, Evanston, IL (US); Robert Wasserman, Wheaton, IL (US)

(21) Appl. No.: 18/241,399

(22) Filed: Sep. 1, 2023

Related U.S. Application Data
(63) Continuation of application No. 16/364,976, filed on Mar. 26, 2019, now Pat. No. 11,854,086.
Application No. 16/364,976 is a continuation of application No. 13/278,432, filed on Oct. 21, 2011, now Pat. No. 10,282,785.
Application No. 13/278,432 is a continuation-in-part of application No. 13/112,825, filed on May 20, 2011, now abandoned.
Application No. 13/112,825 is a continuation of application No. 12/959,108, filed on Dec. 2, 2010, now Pat. No. 8,219,426.
Application No. 12/959,108 is a continuation of application No. 12/903,861, filed on Oct. 13, 2010, now Pat. No. 8,046,246.
Application No. 12/903,861 is a continuation of application No. 12/793,325, filed on Jun. 3, 2010, now Pat. No. 8,046,244.
Application No. 12/793,325 is a continuation of application No. 11/551,595, filed on Oct. 20, 2006, now Pat. No. 7,774,217.
Application No. 11/551,595 is a continuation-in-part of application No. 11/270,611, filed on Nov. 10, 2005, now abandoned.
(60) Provisional application No. 60/629,318, filed on Nov. 19, 2004.

(51) Int. Cl. G06Q 40/08; G06Q 30/02; G06Q 10/10

(52) U.S. Cl. CPC G06Q 40/08; G06Q 30/02; G06Q 10/10

(57) ABSTRACT

Systems and methods provide customizable insurance according to consumer preferences and attributes. An enhanced attributes analysis server may analyze the attributes of a consumer and match these attributes with attributes of current customers of an entity managing the server. The insurance products/plans preferred by the matched customers may then be used to present insurance options to the consumer. In addition, the server may further customize insurance options based on answers to questions that relate to the consumer's specific situation. Further still, the consumer's social network may be used to understand insurance products/plans that may be preferred by the consumer.

### CROSS-REFERENCE TO RELATED APPLICATIONS

The present application is a continuation of U.S. patent application Ser. No. 16/364,976, filed Mar. 26, 2019, and entitled “Delivery of Customized Insurance Products and Services”, which is a continuation of U.S. patent application Ser. No. 13/278,432, filed Oct. 21, 2011, and entitled “Delivery of Customized Insurance Products and Services”, which is a continuation-in-part of U.S. patent application Ser. No. 13/112,825, filed May 20, 2011, and entitled “Processing an Application for Insurance Coverage,” which is a continuation of U.S. patent application Ser. No. 12/959,108 filed Dec. 2, 2010 and entitled “Processing an Application for Insurance Coverage,” which is a continuation of Ser. No. 12/903,861 filed Oct. 13, 2010 and entitled “Processing an Application for Insurance Coverage,” which is a continuation of U.S. patent application Ser. No. 12/793,325, filed Jun. 3, 2010 and entitled “Systems and Methods for Customizing Insurance” which is a continuation of U.S. patent application Ser. No. 11/551,595, filed Oct. 20, 2006 and entitled “Systems and Methods for Customizing Automobile Insurance” and patented as U.S. Pat. No. 7,774,217 which is a continuation-in-part of U.S. patent application Ser. No. 11/270,611, filed Nov. 10, 2005 and entitled “Systems and Methods for Customizing Insurance” which claims priority to U.S. Provisional Application No. 60/629,318, filed Nov. 19, 2004. Each of these applications is incorporated by reference in its entirety herein.

### TECHNICAL FIELD

The present invention relates to systems and methods for customizing insurance and, more particularly, to customizing insurance policies according to consumer preferences. The present invention also provides systems and methods for presenting insurance products/services to consumers.

### BACKGROUND

Today's consumer is presented with an increasing number of purchase options and is more pressed than ever for time. With increasing choices and time demands, consumers can become overwhelmed when reviewing the massive amount of information they encounter in shopping. The pressures attendant the time constraints and information can pervade a consumer's shopping experience, including shopping for insurance.

New technologies, however, now make possible aids to help consumers as they make informed choices about insurance products/services in much less time that they could years ago. The challenge is how to harness those technologies.

### SUMMARY

Methods and systems are provided for creating insurance packages and providing insurance services. Insurance packages may be created by performing research to identify a target population and a set of insurance features desired by the target population. The set of insurance features may be bundled into an insurance package. The packages may include standard components, combinations of optimized components, optimized combinations of standard components and various combinations. The insurance packages may provide automobile insurance, homeowner's insurance and other types of insurance.

In certain embodiments of the invention, aspects of the present invention can be partially or wholly implemented with a computer-readable medium, for example, by storing computer-executable instructions or modules, or by utilizing computer-readable data structures.

Of course, the methods and systems of the above-referenced embodiments may also include other additional elements, steps, computer-executable instructions, or computer-readable data structures.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

All descriptions are exemplary and explanatory only and are not intended to restrict the invention, as claimed. The accompanying drawings, which are incorporated in and constitute a part of this specification, illustrate embodiments of the invention and, together with the description, serve to explain the principles of the invention. In the drawings:

FIG. 1 is an exemplary flow chart for optimizing insurance products, in accordance with an embodiment of the invention;

FIG. 2 is an exemplary chart comparing feature relevance and feature differentiation, in accordance with an embodiment of the invention;

FIG. 3 is an exemplary method of offering insurance, in accordance with an embodiment of the invention;

FIG. 4 shows an exemplary insurance product comprising packages selected from FIG. 3, in accordance with an embodiment of the invention;

FIG. 5 is another exemplary method of offering insurance, in accordance with an embodiment of the invention;

FIG. 6 shows an exemplary insurance product comprising packages selected from FIG. 5;

FIG. 6A shows an optimized insurance policy that includes a combination of standard coverage components, in accordance with an embodiment of the invention;

FIG. 6B shows an exemplary optimized insurance policy that includes standard coverage components and an optional coverage component, in accordance with an embodiment of the invention;

FIG. 7 is a first exemplary system, in accordance with an embodiment of the invention;

FIG. 8 illustrates a process of providing insurance coverage that may be used in connection with various embodiments of the invention;

FIG. 9 is a second exemplary system, in accordance with an embodiment of the invention;

FIG. 10 is a third exemplary system, in accordance with an embodiment of the invention;

FIG. 11 is a flow chart showing the steps of a data-driven process implemented by an enhanced attributes analysis server, in accordance with an embodiment of the invention;

FIG. 12 is a flow chart showing the steps of a customer-driven trade-off process implemented by an enhanced attributes analysis server, in accordance with an embodiment of the invention;

FIG. 13 shows a first user interface screen for inputting information used by an enhanced attributes analysis server in presenting insurance options to a potential customer/customer, in accordance with an embodiment of the invention;

FIG. 14 shows a second user interface screen for inputting information used by an enhanced attributes analysis server in presenting insurance options to a potential customer/customer, in accordance with an embodiment of the invention;

FIG. 15A shows a third user interface screen presenting a detailed insurance option based on customer information entered in previous screens, in accordance with an embodiment of the invention;

FIG. 15B shows a detailed view of the upper section of the screen shown in FIG. 15A, in accordance with an embodiment of the invention; and

FIG. 15C shows a detailed view of the lower section of the screen shown in FIG. 15A, in accordance with an embodiment of the invention.

### DETAILED DESCRIPTION

Generally, insurance is an agreement by which an insurer, sometimes referred to as an underwriter, in exchange for consideration, undertakes to indemnify the insured party against loss, damage, or liability arising from certain risks. The consideration paid by an insured party is typically referred to as a premium, which is paid to keep the insurance in effect. In general, an insurance policy is a contract of insurance that defines the rights and duties of the contracting parties. A typical insurance policy includes limits on the amount and type of risk that the insurer will cover.

Systems and methods consistent with aspects of the present invention provide consumers with insurance products that may help them address some of their individual needs or wants by including features that a particular group may find desirable or appropriate. For the purposes of this application, features may include coverages, terms, and rewards. Generally, a coverage provides a protection or indemnification to the insured. A term includes any word, phrase, or provision of import that determines the nature and scope of an agreement, such as the coverage grant in an insurance coverage or the premium charged. A reward may include a discount, credit, or benefit provided to the insured upon the occurrence of a specified event.

When a feature is not included in a group, that particular feature is referred to as an ala carte feature. Ala carte features refer to coverages, terms, and rewards that are selected by the insured on an individual basis for inclusion in an insurance product.

Features may be grouped together to form a package. For example, one grouping may form a value package for price conscious consumers, another grouping may form a protection plus package providing additional features, and yet another grouping may form a platinum package including yet more additional features. An insurance product may also include a standard package that includes coverages required by state law, such as bodily injury liability coverage and property damage liability coverage. Coverages in a standard package may also include personal injury protection coverage, medical payment coverage, uninsured motorist coverage, underinsured motorist coverage, collision coverage, and comprehensive coverage.

Most states mandate minimum types and levels of automobile insurance coverage. For example, a state may require liability coverage with mandated minimum coverage limits. Depending upon the particular state, some common coverages may be mandatory or optional. Other coverages, such as collision and comprehensive, may be required by banks or financial institutions as a prerequisite to obtain vehicle financing.

In the marketplace today, an automobile insurance product offering might include standard coverages required by state law and/or financial institutions. A standard package includes coverages and coverage limits that meet minimum state law requirements. A standard package may also include other coverages that are required by financial institutions. Additionally, insurance companies may offer coverages and coverage limits that are not required by state law or by financial institutions. Coverage examples include towing reimbursement and car rental reimbursement.

Automobile insurance consumers find value in optional coverages designed around potential risks uniquely associated with driving and or repairing of vehicles. Some examples include towing and emergency repair coverage. A car rental reimbursement coverage may help pay for the use of a rented vehicle while the insured vehicle is being repaired due to a loss caused by a covered peril. Other personal coverages are also offered in the event certain covered perils occur.

The following provides a summary of an exemplary basic optimized package, two additional optimized packages, and various exemplary ala carte features that may be added by a consumer to one of the optimized packages. For example, a basic package might include a reduced premium by adding in a few terms. It is designed as an alternative for the customer particularly concerned about price. In particular, a customer may be required to participate in an arrangement that automatically makes periodic (for example, monthly) deductions from the insured's savings or checking account to pay the premium and other charges or fees associated with the insurance. Customers will be charged an early termination fee (such as $100) if the insurance is terminated by the insured, which might include the insured's failure to accept a renewal offer, or terminated for non-payment of premium, within a specified period of time after the package is added.

Another optimized package might offer an accident waiver enhancement feature and a safe driving deductible reward feature. The accident waiver enhancement feature might specify that the first rate-affecting accident that occurs will not cause the loss of certain discounts or result in the application of any accident surcharges. Subsequent rate affecting accidents will not cause the loss of the discounts or the application of any accident surcharges if the insured has not received this waiver in the thirty-six month experience period ending on the date of the accident. Similarly, a ticket forgiveness feature might specify that a ticket for a traffic violation will not cause the loss of certain discounts or result in a policy not being renewed.

The safe driving deductible reward feature might provide, upon enrollment, that the customer will receive an initial reduction (such as $100) in his or her collision deductible. For each twelve month experience period the policy is not assigned an accident, the insured will receive an additional reduction (up to a maximum $500 reduction) in their collision deductible that will apply to all covered collision claims during the next policy period.

Yet another optimized package might offer an accident waiver enhancement plus feature, a safe driving deductible reward feature, and a safe driving bonus feature. With the accident waiver enhancement plus feature, neither a single accident nor multiple accidents will cause the loss of certain discounts or the application of accident surcharges as long as the accidents occur while this feature is part of the policy. The safe driving bonus feature may provide if the policy is not assigned an accident for a designated six-month experience period, the insured will receive 5% of their previous term's premium for major coverages as a credit that can be applied toward the next six-month premium.

Both of the above-described exemplary optimized packages may also allow the customer the opportunity to add, for an additional premium, an additional feature in the form of a new car expanded protection coverage feature on an automobile that has collision and comprehensive coverages. The coverage provided by this feature will continue while collision and comprehensive coverages are maintained and will be removed at the first renewal that is effective in the calendar year that is three years greater than the auto's model year.

The new car expanded protection coverage feature may provide that, in the event of a covered loss to an automobile other than a total loss, the insurance carrier will pay to repair the auto without a deduction for depreciation. The repair coverage may not apply to losses caused by fire, theft, larceny, or flood. Furthermore, the amount payable will be reduced by any amounts paid or payable under the collision or comprehensive coverages as well as any applicable collision or comprehensive deductible.

The new car expanded protection coverage feature may also provide that, in the event of a covered total loss, the insurance carrier will pay to replace the automobile with a new one of the same make and model with the same equipment or, if a new automobile of the same make and model with the same equipment is not available, a new automobile that is similar in size, class, body type and equipment (subject to a price limitation described in the coverage). The replacement coverage may not apply to leased vehicles or to losses caused by fire, theft, larceny, or flood. Furthermore, the amount payable will be reduced by any amounts paid or payable under the collision or comprehensive coverages, any applicable collision or comprehensive deductible, and the dollar amount of any unrepaired damage that occurred prior to the total loss of the automobile.

The new car expanded protection coverage feature may also provide that, in the event of a covered total loss, if the amount the customer owes under the original automobile loan or automobile lease exceeds the actual cash value of the automobile at the time of loss, the insurance carrier will pay the difference between the amounts. The amount payable may be reduced by any overdue loan or lease payments (and any financial penalties associated with those overdue payments), the transfer or rollover of a previous outstanding loan or lease balance from another vehicle to the original loan or lease for the covered automobile, the dollar amount of unrepaired damage which occurred prior to the total loss, all refunds paid or payable to the customer as a result of the early termination of the automobile loan or automobile lease agreement (including financed warranty/extended service contracts), and any amount paid or payable under the replacement protection of the new car expanded coverage protection feature.

In forming the above exemplary packages that are offered for sale by an insurance carrier, one forming the package offerings might decide to consider consumer “need states” to group features into packages offered for sale. Need states refer to the complex web of rational and subconscious triggers that prompt a consumer to make a product selection. Need states may be prompted by a consumer deciding that he or she needs or wants to obtain a product. Furthermore, they are generally a result of an individual's situation at a particular point in time. Life stage events, such as a new driver in the family, shift consumers' need states. Of course, automobile insurance consumers may have varied circumstances, and consequently, differing insurance needs and wants. One may be a student with limited resources, and as a result, might select state mandated coverage. Another may be near retirement and focused on protection of assets and convenience of services.

Systems and methods consistent with aspects of the present invention identify distinct groupings of insurance consumers with similar need states and identify the most commonly desired optional features that consumers might chose to help meet their needs. Optional features are then combined by the system into optimized packages of insurance products that are offered for sale to consumers. By grouping features into packages that align with common need states, the offered products will be attractive to persons in need states that were considered when designing the packages.

An “optimized package” includes a set of insurance features that are packaged to help address the needs and wants of consumers in a particular grouping (e.g., geographic or demographic based groups, etc.). Ala carte features may also be optimized. For example, ala carte features may be optimized by grouping certain ala carte features together that share an attribute. Accordingly, both optimized features and optimized ala carte features include coverages, terms, and rewards that are selected from a group that shares an attribute. The shared attribute allows the features to be grouped around a common theme. For example, a value grouping may include features designed around lower price. A protection theme may include features optimized around protecting assets. For the most part, features are grouped to share an attribute, however, features that are grouped around a common theme may also include one or more features that do not share the common theme or are based on a regional theme.

More than one package may be grouped together to form a “plan.” A plan refers to a grouping of a standard package with at least one optimized package of features. A consumer may also add ala carte features, or optimized ala carte features, to a plan on an individual basis.

The process by which packages are designed may involve consideration of market theories. When looking to a market, one needs to identify the individuals that might decide to purchase a product. A group of persons that may be interested in or share a need for a particular product or products is defined as a target population. Accordingly, the target population is the group to be reached through some action or intervention and may refer to groups with specific characteristics. Market segmentation refers to the process of grouping persons in a target population into smaller subgroups called market segments. A market segment is a group within a heterogeneous market consisting of consumers or organizations with relatively homogeneous needs and wants. Consumers in a market segment are expected to respond to a given set of marketing stimuli in a similar manner. Ideally, individuals within a market segment will likely have similar feelings about a marketing mix comprised of a given product, sold at a given price, distributed in a certain way, and promoted in a certain way. Accordingly, a market segment is a more specifically defined group within the target population.

A target population or a market segment may share one or more common characteristics that statistically describe the persons within the target population or market segment. Characteristics may include gender, age, occupation, marital status, and family size. As will be discussed further below, other characteristics that a target population may share include credit risk, level of risk tolerance, value of assets needed to be protected, willingness of a person to pay more for a lower deductible, and desire for predictable out-of-pocket expenses annually, among other things.

To select features that might appeal to a particular target population or market segment, features may be grouped together along marketing demand parameters. Groups of features are offered in different product structures, which are discussed in further detail below. Utility-based groupings maximize product acceptance of product packages by statistically predicting consumer demand based on multidimensional analysis of consumer motivations. These motivations are then compiled through a demand simulator to identify and target product requirements that may be attractive to various segments of the consumer population. A demand simulator measures overall demand potential as well as consumer preferences for various product features and brands. By using a demand simulator, it is possible to identify the features that consumers might want most, and then measure the price they are willing to pay for them. Demand simulators are discussed more fully below.

For example, certain features have more universal consumer appeal while other features appeal to a specific consumer characteristic. An optimization process creates focused sets of features. The process may organize product packages around central motivation factors, such as price points and common feature acceptance. Using feature interest as a motivating factor, the most popular features can be grouped to form a set of features that are both universally popular and provide an acceptable profit to an insurance carrier.

Differentiation is introduced by adding features to packages that specifically address the motivations of a specific consumer group. For example, some consumer groups are interested in security features, while others may have young drivers in the household. Because some consumers are highly driven by features while others are driven by price, package structures may be optimized based on price to motivate a consumer segment. Alternatively, package structures may be optimized based on features that appeal to less price-sensitive members of the consumer population. In addition, some optimized package structures may be based upon both price and feature considerations.

Insurance products generated according to the present invention may be offered for sale in a variety of manners. For example, consistent with the present invention, optimized packages may be offered through any form of visual display, either electronically or by the use of brochures, posters, signs, standing displays, and any other form of visual and/or written communication. In addition, one may offer optimized packages through an insurance carrier's agents in person, over the telephone, or via the Internet. In an Internet implementation, or over the telephone using a voice recognition system, such interactions may occur automatically.

Reference will now be made in detail to exemplary embodiments of the invention, examples of which are illustrated in the accompanying drawings. Wherever possible, the same reference numbers will be used throughout the drawings to refer to the same or like parts.

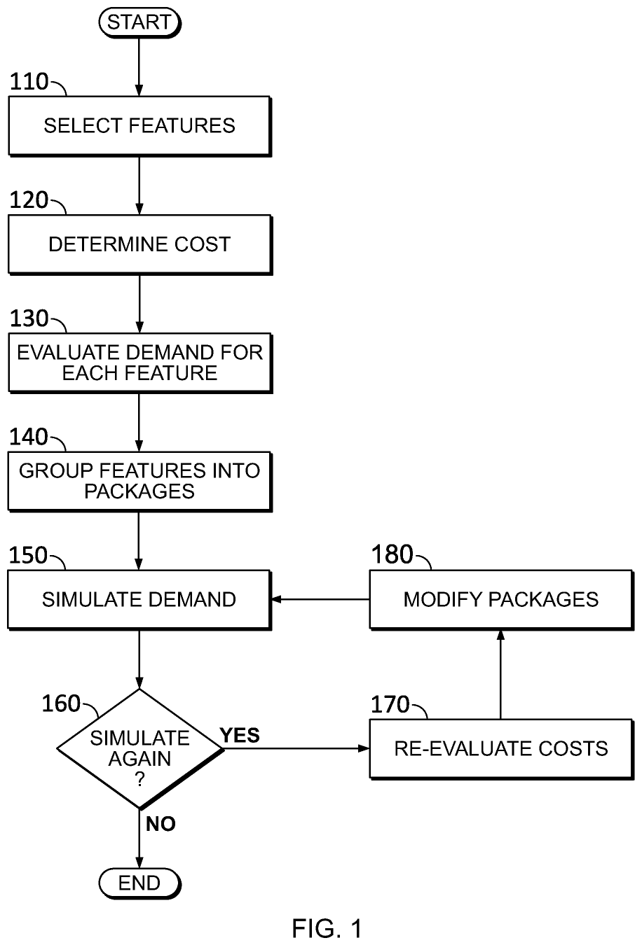

FIG. 1 is a flow chart for optimizing customizable insurance products, in accordance with an embodiment of the invention. One may optimize insurance products by designing packages using a process that takes into account the considerations discussed in further detail below.

First, features are identified as candidates to be offered as part of various packages, which together form an insurance product. Step 110. To identify those features that one might consider as candidates, business performance data may be analyzed. Business performance data may include different subsets of data obtained by collecting existing information from the marketplace to analyze for trends and to understand the landscape of available options. A possible subset of business performance data is market-share data, which includes industry data used to evaluate current levels of market share for particular consumers to determine demand generated by specific product offerings. In this step of the process, one might identify a target population and/or a market segment.

Other categories of data considered in this step include industry-product-offering data and internal-pricing data. Industry-product-offering data includes an evaluation of the products and features offered in policies from various insurance carriers. In addition, this data may be supplemented by internal pricing data proprietary to the insurance carrier conducting the demand simulation.

Internal-pricing data may include the insurance carrier's premiums, loss, and expense data so that the cost of features can be taken into account. Internal-pricing data allows one to compare a specific insurance carrier's ability to provide a product to consumers at a price consumers are willing to pay. Other ways of arriving at candidate features include brainstorming with experts, examining the current and past marketplace, and by soliciting and receiving suggestions and input from consumers and agents.

Next, the cost of each candidate feature is determined. Step 120. In determining costs of the candidate features, the losses that are expected for a particular feature are examined when determining the premium that consumers will pay.

Once candidate features and costs are determined, the demand for each feature in the marketplace is evaluated. Step 130. During the evaluation, consumer preferences are evaluated to form price utility curves, which are created after conducting consumer research to better understand consumer preferences for each feature or combination of features.

The process of evaluating demand may include collecting information using focus groups selected from different geographic regions. For example, persons participating in focus groups can be selected across all age groups that have actively shopped for insurance during an appropriate time frame. Selection of groups may occur on the basis of any identified target population and/or market segment. During this step, features may be eliminated from further consideration based upon the focus groups' preferences. In addition, focus groups may provide survey information identifying the price each individual was willing to pay for certain features. Such considerations may involve an evaluation of sample packages containing different combinations of features offered at different prices.

Next, features may be grouped into possible packages. Step 140. During this step, cost prohibitive features may be eliminated from packages because consumers may not be willing to pay the price of a particular feature. Also, strategic alternatives data may be examined, including price-point data and variable-feature-level data. Price point data includes an evaluation of a particular insurance carrier's current prices to competitors' prices and includes an evaluation of the impact of adding packaged features. Variable feature level data may be considered to describe the most compelling packages of features. Variable feature level data is derived from consumer research and includes uniqueness and differentiation of features to evaluate the best features and how features should be grouped in packages.

In addition, incremental costs of strategic alternatives data includes variable-feature-cost data and fixed-cost-investments data. Variable-feature-cost data describes an insurance carrier's proprietary loss and expense data and is used to determine a cost to offer a given feature. Fixed-cost investments data takes into account systems, infrastructure, and other costs associated with implementation of an optimized product architecture.

When designing packages, another concept that may be incorporated into the process is that of self-selection. For example, packages should include features that appeal to consumers in a particular need state such that these consumers will recognize the value of a particular package and consider including it in their insurance selections.

Next, demand is simulated using a demand simulator. Step 150. The demand simulator estimates the number of individuals that will purchase a particular product offering. Optimization of packages is accomplished by iteratively trying all possible package combinations or by determining which features may be substituted for other features in the most optimal packages to arrive at a set of features that provides an arrangement of features that a consumer would find of value.

The demand simulator may be implemented as a software module, which processes data provided to it. During the operation of the demand simulator, user input may provide the ability to select different features and to alter inputs to the module. Consistent with the present invention, processing may also occur automatically at the direction of optimization software including automated logic.

Features that are used by the demand simulator may be selected with utility-based product segmentation. As discussed above, price-utility curve data may be used to determine packages. A utility value for each feature may be determined through consumer research to identify the features most attractive to the overall target population as well as to subsets of the target population that form market segments. Features are then grouped into packages, and groups of packages form an insurance product.

After the demand simulator provides an initial processing of features, a user may decide whether to simulate demand again. Step 160. If the user decides to stop, the process ends. If the user decides to continue, the process goes to Step 170. In Step 170, processing may be further refined by re-examining costs of packages by examining different feature combinations based on particular judgment criteria. For example, if the cost of offering a particular package is high, it may be identified using variable-feature-cost data and fixed-cost investment data, as described above in connection with Step 120.

After inspecting the costs, certain features may be removed or added to packages. Step 180. User input may further provide the ability to select different features and to alter inputs to the module. The process then returns to simulate demand for the newly modified packages. Step 150.

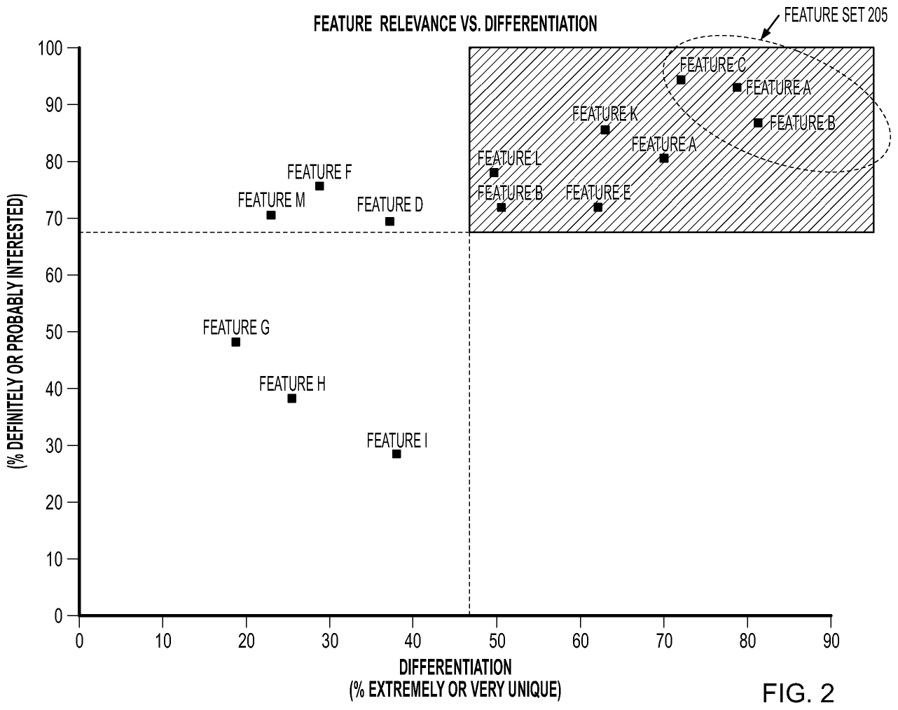

FIG. 2 shows an exemplary chart comparing feature relevance and feature differentiation used to perform analysis used in optimizing features for packages. By plotting the data as shown in FIG. 2, it is possible to determine a feature set 205 that includes features that are highly relevant and distinctive. Such a process may be done for an entire population to arrive at feature set 205 and may also be done for sub-segments based on characteristics common to the sub-segments to determine the packages that most appeal to a particular group or subgroup.

Accordingly, research may be performed to identify a target population and a set of insurance features desired by the target population. The set of insurance features are bundled into an insurance package. A cost of the insurance package may be determined and the insurance package may be offered for sale.

Furthermore, the research to identify the insurance features may be carried out through an optimization process, as described above. In some embodiments, the optimization process is based upon consumer factors. In other embodiments, the optimization process is based also upon financial criteria that provide the insurance company with an acceptable profit. The research may also include examining common characteristics of the target population or of a market segment within the target population.

This procedure may be repeated for additional market segments. A set of ala carte features may also be identified and a cost for each of the ala carte features may also be identified, along with determining corresponding prices for the ala carte features and offering the ala carte features for sale at the corresponding prices.

In one embodiment of the invention, an optimized package includes a basic set of insurance features and may be offered for sale along with the insurance package. A standard package may include a set of insurance features required by a governing law. Alternatively, a standard package may also include a set of insurance features required by a financial institution.

For example, an optimized package may additionally include a set of insurance features created by performing research to identify a target population or a market segment. Alternatively, a standard package may also be combined with the optimized package to form a plan. Sets of additional insurance features may also be selected to form additional packages. Each plan may include a standard package and an optimized package.

In addition, a third party may sell optimized packages without a standard package. Such a situation might involve a third party's sale of optimized packages as additions to an existing insurance product. An insurance carrier has sold the existing insurance product to a consumer, who has then gone to a third party from which the consumer may obtain the optimized packages. The optimized packages, however, may be created or selected consistent with the principles of the present invention.

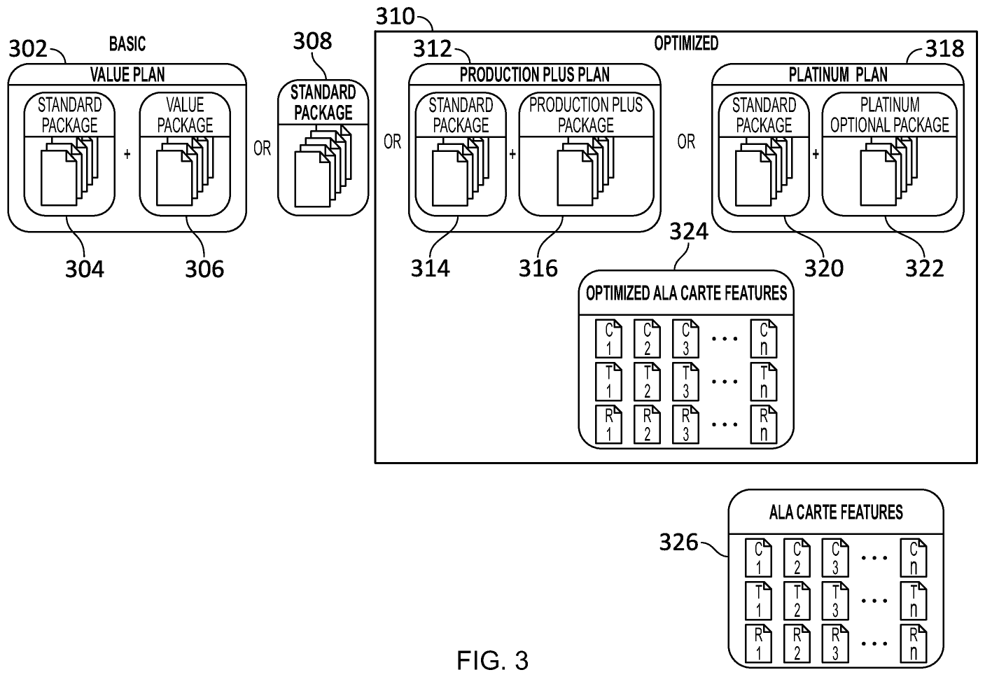

FIG. 3 is an exemplary method of selling insurance, in accordance with an embodiment of the present invention. As shown in FIG. 3, a consumer is offered a variety of options. For example, a consumer may only want to purchase a basic insurance product. That consumer may select a standard package 308. Alternatively, the consumer may select a value plan 302, which includes a standard package 304 and a value package 306 with additional features.

However, if a consumer would like to purchase more than a basic insurance product, the consumer may select from optimized package group 310. FIG. 3 includes two exemplary optimized packages: a protection plus plan 312 and a platinum plan 318. Protection plus plan 312 includes a standard package 314 and a protection plus package 316. Protection plus package 316 may include features such as a repair/replace feature and a loan/lease-gap coverage feature. Alternatively, the consumer may select platinum plan 318, which includes a standard package 320 and a platinum options package 322. Platinum options package 322 may include features such as a repair/replace feature, a loan/lease-gap coverage feature, a monetary death indemnity feature, and a full roadside assistance feature.

In addition, the consumer may select from optimized ala carte features 324. Optimized ala carte features 324 are individual features sold separately as add-ons to certain optimized packages. Optimized ala carte features 324 have been keyed as a group to share an attribute. In addition, the consumer may also select from a general group of ala carte features 326 that have not been optimized. As shown in FIG. 3, there are many possible combinations and variations from which a consumer may select to form an insurance product.

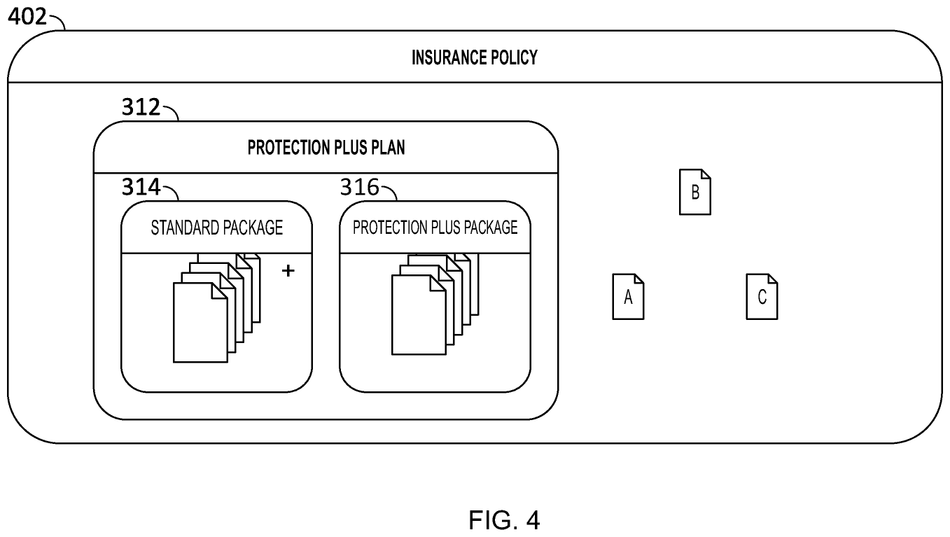

FIG. 4 shows an exemplary insurance product comprising packages selected from FIG. 3. The example shown in FIG. 4 displays a possible selection that a consumer may make from the options provided in FIG. 3 to form insurance product 402. Insurance product 402 includes protection plus plan 312, which includes standard package 314 and protection plus package 316. In addition, insurance product 402 includes several ala carte features labeled A, B, and C, which may or may not be optimized.

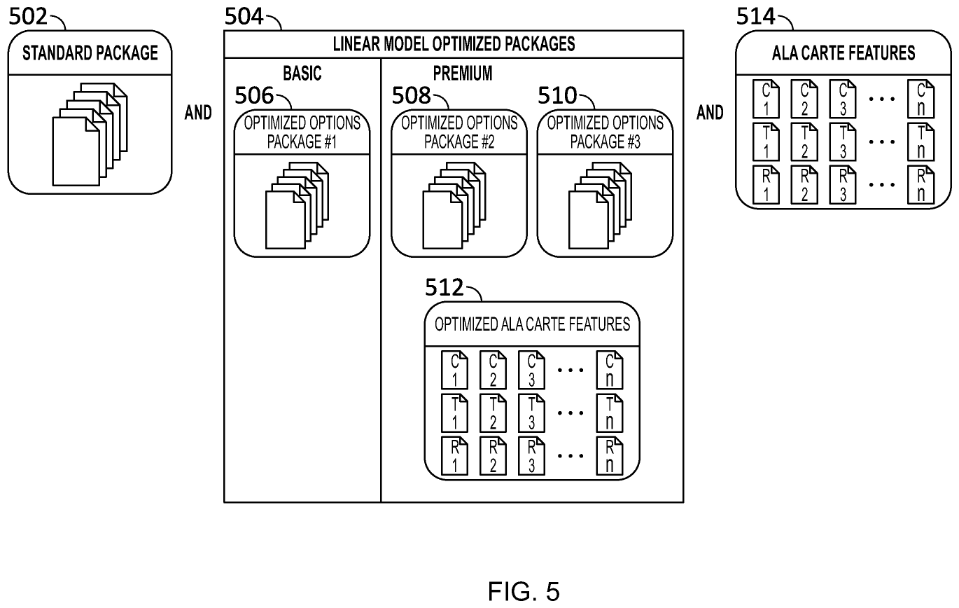

FIG. 5 is another exemplary method of selling insurance in accordance with an embodiment of the invention. In the method shown in FIG. 5, a consumer combines packages in a linear fashion to form an insurance product. For example, the consumer selects a standard package 502. Since standard package 502 meets the minimum requirements for an insurance product, the consumer may decide only to purchase standard package 502. However, the consumer may also decide to select additional optimized packages from optimized package group 504. For example, the consumer may also select optimized options package 506, which is considered a “basic” optimized package. In addition, however, the consumer may also select optimized options package 508 and/or optimized options package 510. These additional optimized packages are considered “premium” packages because they offer additional features at a cost greater than the basic optimized package. Furthermore, optimized packages 506-510 may include features optimized in a manner consistent with the present invention. In some embodiments, a consumer may be required to first select, for example, a particular optimized options package before the consumer may select a further optimized package. Such a “tiered” arrangement requires the purchase of an initial optimized package as a prerequisite before additional optimized packages may be purchased.

Once the consumer has selected optimized options package 508 or optimized options package 510, the consumer may also select any one or more optimized ala carte features 512. Additionally, a consumer that has selected any one of optimized options packages 506-510 may also select one or more ala carte features 514. As shown in FIG. 5, there are many possible combinations and variations from which a consumer may select to form an insurance product.

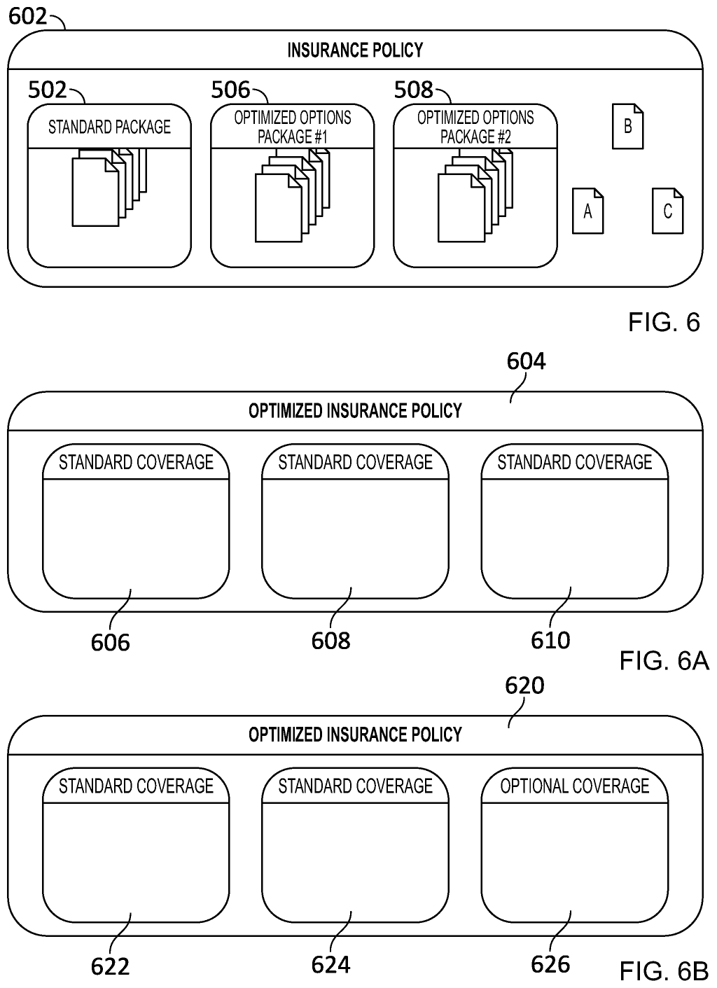

FIG. 6 shows an exemplary insurance product comprising packages from FIG. 5. The example in FIG. 5 shows a possible selection that a consumer may make to form insurance product 602. Insurance product 602 includes standard package 502, optimized package 506, and optimized package 508. In addition, insurance product 602 includes several ala carte features A, B, and C, which may or may not be optimized.

Those skilled in the art will appreciate that aspects of the invention may be applied to create a variety of different insurance products. The insurance products may include combinations of optimized components, optimized combinations of standard components and combinations of both. FIG. 6A, for example, shows an optimized insurance policy 604 that includes a combination of standard coverage components 606, 608 and 610. In one implementation, optimized insurance policy 604 is a homeowner's insurance policy. FIG. 6B illustrates an exemplary optimized insurance policy 620 that includes standard coverage components 622 and 624 and an optional coverage component 626. Optional coverage component 626 may include a grouping of insurance features that share a common attribute.

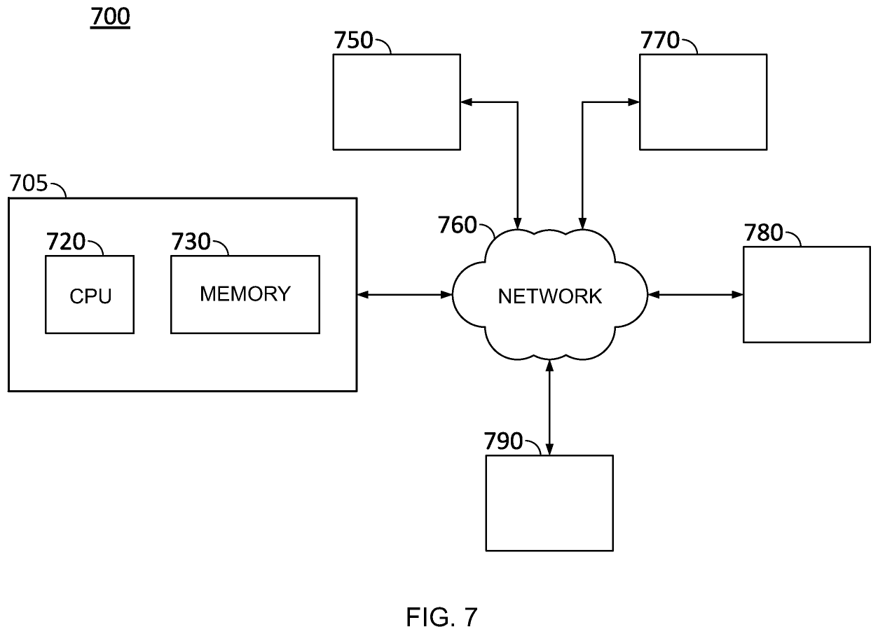

FIG. 7 illustrates a system 700 that may be used to implement at least some of the methods described above, in accordance with an embodiment of the present invention. System 700 includes a server 705, connected to a network 760, including a CPU 720 and a memory 730. Software loaded into memory 730 from, for example, a disk drive (not shown) at the direction of CPU 720 may be used to implement a program for optimizing insurance in a manner consistent with various embodiments of the present invention. For example, the software may execute instructions for performing demand simulation to analyze data and to form optimized packages. In addition, memory 730 may store, for example, a database (not shown) of market data and store research conducted to design packages.

Additionally, network 760 provides communications between the various entities in system 500, such as user terminals 770-790. Network 760 may be a shared, public, or private network and encompass a wide area or local area. Further, network 760 may be implemented through any suitable combination of wired and/or wireless communication networks. By way of example, network 760 may be implemented through a wide area network (WAN), local area network (LAN), an intranet, or the Internet.

Terminals 770-790 allow a user to exchange information with server 760. Terminals 770-790 may be any type of appropriate device for communicating with server 705 over network 760. For example, terminal 770 may be a PDA running a program for communicating with server 705, while terminal 780 may be a desktop type computer running a web browser for communicating with server 705 via the Internet. Terminal 790 may be a standard landline telephone or wireless phone.

Users may access server 705 via network 760 to customize an automobile insurance product through a web browser running on, for example, terminal 780. A website may include options to provide information or to fill out an application, and may present the user with a series of screens prompting the user to make various selections. The user may make appropriate selections to customize the insurance product. Additionally, a user at terminal 790, a telephone, may contact a consumer service representative at terminal 750. The consumer service representative may assist a consumer through a process that the customer can use to consider options for customizing an insurance product by asking a series of questions. During the process, the consumer service representative may use software running on terminal 750, and may send data to and from server 705.

Aspects of the invention may be used in connection with automobile insurance, homeowner's insurance and other types of insurance. One of skill in the art will readily recognize how to adapt the methodology described above to a variety of areas of insurance. For example, consistent with aspects of the present invention, an insurance carrier may expand its homeowner's insurance offerings to consumers by identifying features with appeal and profitability to design packages of related features at different pricing points. Customizable homeowner's insurance may include a standard package of typical coverages, and a consumer may further select optimized packages of features in a manner similar to that discussed above.

A homeowner's insurance product typically covers a building or structures on the premises and household personal property. A typical homeowner's insurance product usually also includes certain personal liability coverage and coverage for medical payments to others. Additional coverages or features are purchased ala carte.

Homeowner's insurance consistent with aspects of the present invention provides optional coverages that reflect different lifestyles and life stage needs. In particular, by implementing a methodology consistent with that described above, one may also create optimized homeowner packages. Optimized solutions may include coverages that are popular with most homeowners, as well as optimized coverages, that align with the wants and needs of a given consumer. Consumers may be offered optimized packages of coverages and terms that share a common attribute. Common attributes may relate to electronic data recovery, home enterprises, identity restoration, music & photography, prized possessions, jewelry, sports & leisure, yard & garden or other areas that present particular liability concerns to at least a group of consumers.

Optional insurance component 626 (shown in FIG. 6B) may include a grouping of insurance features that share a common attribute, such as one of the attributes described above. An electronic data recovery component may provide reimbursement for expenses incurred from an attempt to restore lost data resulting from a covered loss or computer virus. The coverage may have a limit, such as $5,000. A home enterprise coverage component may bundle increased limits for consumers who work from their home in an office/studio setting and desire additional protection for business property, liability, and/or office/studio equipment and furniture. In one embodiment of the invention, a home enterprise coverage component includes the features of an electronic data recovery component. An identity restoration component may reimburse consumers for lost wages and other covered expenses resulting from identity theft. The coverage may have a limit, such as $25,000 and may have no deductible. A music & photography component may include a bundle of increased limits for consumers who have musical instruments and photography equipment. A prized possessions component may include a bundle of increased coverage limits for consumers who have acquired certain types of assets, such as silverware, jewelry, furs, etc. A sports & leisure component may include a bundle of increased limits for consumers who have sports equipment and/or small watercraft.

A yard & garden component may include a bundle of increased limits for trees, shrubs, landscaping and other plants. The bundle may include coverage for motorized land vehicles used to service the residence premises. An increased limit, such as 10% or $1,000 per tree, may be included for replacement and debris removal of trees for certain perils. In certain embodiments increased debris removal coverage may be included in the bundle for the perils such as windstorm, hail, weight of ice, snow and sleet.

One of skill in the art will appreciate that aspects of the invention may be used to create insurance coverage packages that include standard homeowner's coverage components and at least one homeowner's component having a grouping of insurance features that share other common attributes. Exemplary common attributes may relate to home value protection, identity theft, blanket protection of valuables, limited personal umbrella policy coverage and any other attributes or combination of attributes that are desired by at least a group of consumers.

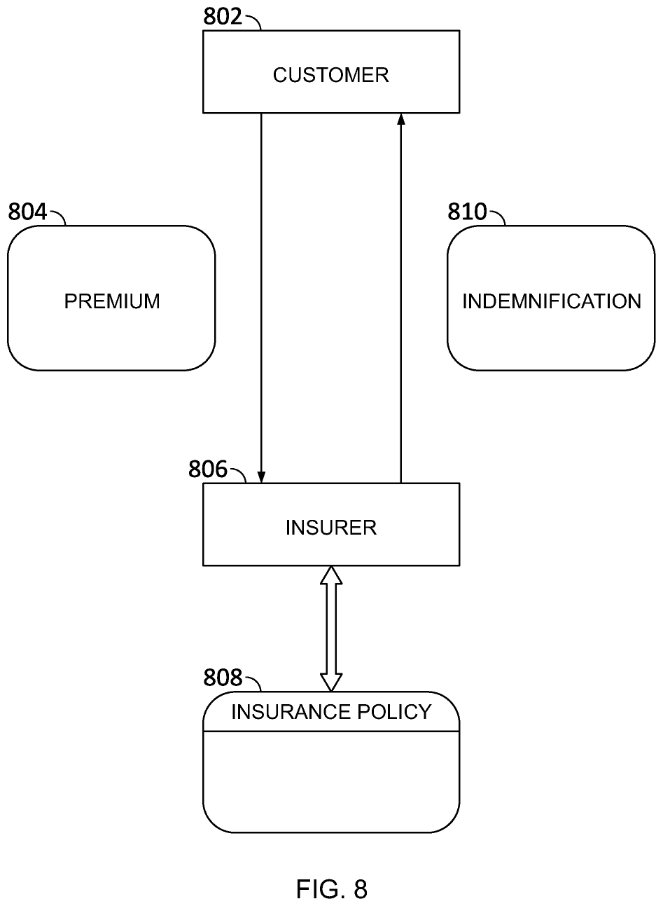

FIG. 8 illustrates a process of providing insurance coverage that may be used in connection with the embodiments of the invention described herein. A customer 802 pays a premium 804 to an insurer 806. The premium is provided in exchange for insurance coverage described in an insurance policy 808. Insurer 806 provides indemnification 810 to customer 802 when an event covered by insurance policy 808 occurs.

Personal automobile and homeowners insurance are examples of property and casualty insurance offerings. One skilled in the art will recognize that the above-described methodology is applicable to other types of insurance products as well, such as commercial insurance for business customers. In addition, an insurance carrier may offer annuity products to consumers for retirement or financial planning purposes by identifying features with appeal and profitability to design packages of related features at different pricing points or expense levels. Customizable annuity products may include a standard annuity with typical accumulation, return, and payout features. A consumer may further select enhanced packages of features in a manner similar to that discussed above for automobile insurance.

Additional embodiments of the present invention are possible, each designed to cover other classes of insurable risk, including but not limited to, mortality risk and life insurance products; morbidity risk and health and long-term care insurance products; as well as professional practice risk and liability insurance.

Although not common in today's marketplace, it is possible to apply the disclosed methodology to so-called hybrid or multi-risk products that combine the coverages of two or more products from different classes of insurance risk into a single product. Customizable hybrid products may include a standard package across two or more risk classes with typical features in each class and a consumer may further select enhanced packages of features in a manner similar to that discussed above for automobile insurance.

In other aspects, the present invention provides systems and methods for allowing an entity (e.g., an insurance company) to present insurance product options to a potential customer/customer by accessing information stored about the entity's current customers that may share one or more attributes with the potential customer/customer (e.g., to determine the need states of the potential customer/customer).

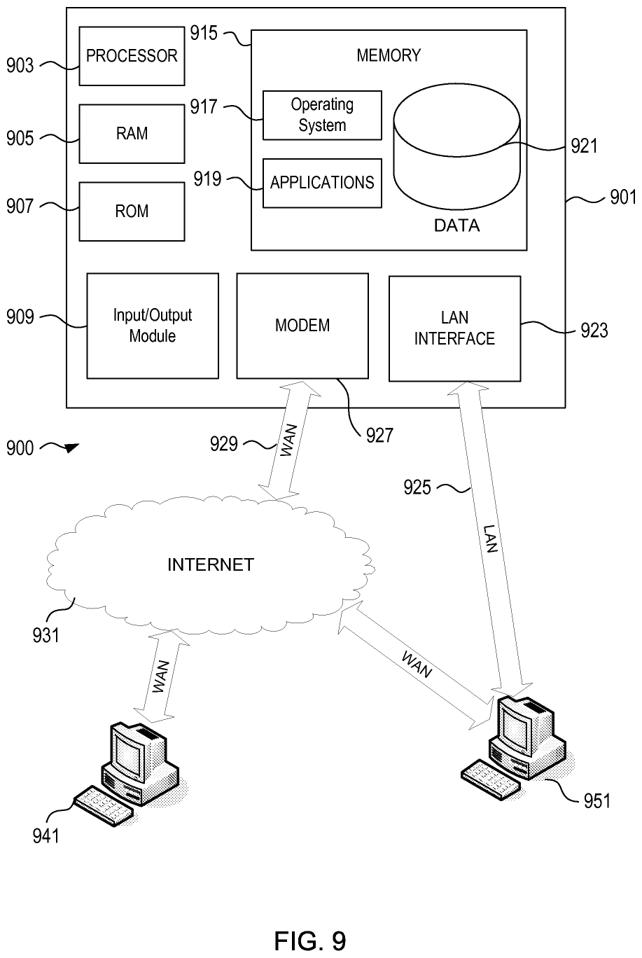

FIG. 9 illustrates a block diagram of an enhanced attributes analysis server 901 (e.g., a computer server) in communication system 900 that may be used according to this illustrative embodiment of the disclosure. The server 901 may have a processor 903 for controlling overall operation of the enhanced attributes analysis server 901 and its associated components, including RAM 905, ROM 907, input/output module 909, and memory 915.

I/O 909 may include a microphone, keypad, touch screen, and/or stylus through which a user of enhanced attributes analysis server 901 may provide input, and may also include one or more of a speaker for providing audio output and a video display device for providing textual, audiovisual and/or graphical output. Software may be stored within memory 915 and/or storage to provide instructions to processor 903 for enabling server 901 to perform various functions. For example, memory 915 may store software used by the server 901, such as an operating system 917, application programs 919, and an associated database 921. Processor 903 and its associated components may allow the server 901 to run a series of computer-readable instructions to present an insurance product/plan offering for a potential customer/customer of an entity (e.g., an insurance company) managing server 901. For instance, processor 903 may perform this operation by processing data associated with the potential customer/customer to determine various attributes of the potential customer/customer. In addition, processor 903 may access a database storing information related to insurance coverage details associated with current customers of the entity managing server 901. Further still, processor 903 may determine which current customers have attributes similar to those of the potential customer/customer being evaluated; once a matching set of current customers is found, processor 903 may use the insurance product/plan details of the matched customers to determine an insurance product/plan offering for the potential customer/customer.

The server 901 may operate in a networked environment supporting connections to one or more remote computers, such as terminals 941 and 951. The terminals 941 and 951 may be personal computers or servers that include many or all of the elements described above relative to the server 901. Alternatively, terminal 941 and/or 951 may be data stores for storing insurance product details related to current customers of an entity managing server 901. The network connections depicted in FIG. 9 include a local area network (LAN) 925 and a wide area network (WAN) 929, but may also include other networks. When used in a LAN networking environment, the server 901 is connected to the LAN 925 through a network interface or adapter 923. When used in a WAN networking environment, the server 901 may include a modem 927 or other means for establishing communications over the WAN 929, such as the Internet 931. It will be appreciated that the network connections shown are illustrative and other means of establishing a communications link between the computers may be used. The existence of any of various well-known protocols such as TCP/IP, Ethernet, FTP, HTTP and the like is presumed.

Additionally, an application program 919 used by the enhanced attributes analysis server 901 according to an illustrative embodiment of the disclosure may include computer executable instructions for invoking functionality related to generating a series of questions aimed at determining current customers that have similar attributes to a potential customer/customer.

Enhanced attributes analysis server 901 and/or terminals 941 or 951 may also be mobile terminals including various other components, such as a battery, speaker, and antennas (not shown).

The various embodiments of the invention are operational with numerous other general purpose or special purpose computing system environments or configurations. Examples of well-known computing systems, environments, and/or configurations that may be suitable for use with embodiments of the invention include, but are not limited to, personal computers, server computers, hand-held or laptop devices, multiprocessor systems, microprocessor-based systems, set top boxes, programmable consumer electronics, network PCs, minicomputers, mainframe computers, and distributed computing environments that include any of the above systems or devices, and the like.

Embodiments of the invention may be described in the general context of computer-executable instructions, such as program modules, being executed by a computer. Generally, program modules include routines, programs, objects, components, data structures, etc. that perform particular tasks or implement particular abstract data types. Embodiments of the invention may also be practiced in distributed computing environments where tasks are performed by remote processing devices that are linked through a communications network. In a distributed computing environment, program modules may be located in both local and remote computer storage media including memory storage devices.

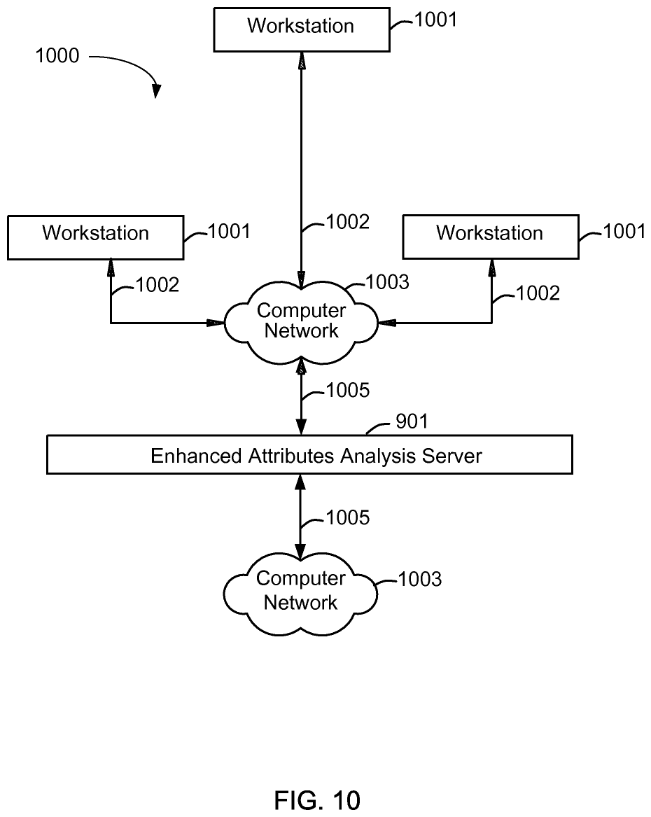

Referring to FIG. 10, an illustrative system 1000 for implementing methods according to embodiments of the invention is shown. As illustrated, system 1000 may include one or more workstations/servers 1001. Workstations 1001 may be local or remote, and are connected by one or more communications links 1002 to computer network 1003 that is linked via communications links 1005 to enhanced attributes analysis server 901. In certain embodiments, workstations 1001 may store customer data used by server 901 for presenting insurance plan/product options to a potential customer/customer of the entity managing server 901, or, in other embodiments, workstations 1001 may be different points at which the enhanced attributes analysis server 901 may be accessed. In system 1000, enhanced attributes analysis server 901 may be any suitable server, processor, computer, or data processing device, or combination of the same.

Computer network 1003 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 1002 and 1005 may be any communications links suitable for communicating between workstations 1001 and server 901, such as network links, dial-up links, wireless links, hard-wired links, etc.

The steps that follow in the Figures may be implemented by one or more of the components in FIGS. 7, 9, and 10 and/or other components, including other computing devices.

In certain aspects, server 901 may present insurance product/plan options based on similarities between attributes of current customers of the entity managing server 901 and attributes of a potential customer/customer being evaluated for a new insurance product/plan. For instance, server 901 may evaluate these similarities based on a common life-phase scenario (e.g., college graduate, newly married, first child, retired, death in the family, death of spouse, etc.) that the potential customer/customer shares with current customers of the entity managing server 901.

In other aspects, server 901 may present insurance package/plan options to a potential customer/customer by examining the social network of the potential customer/customer (e.g., via Twitter®, Facebook®, etc.) In this aspect, server 901 may interface with the social network of the potential customer/customer and may determine the insurance products/plans preferred by various members of the social network. Server 901 may then present some or all of the features associated with insurance products preferred by the social network to the potential customer/customer. In addition, server 901 may involve the social network of a potential customer/customer after an initial insurance product has been presented to the potential customer/customer. In this aspect, server 901 may present the same or a similar insurance product option to each member of a social network of a potential customer/customer.

Upon receipt of a request for a new insurance product/plan, server 901 may process any customer data (e.g., name, address, driver's license number, answers to a predetermined set of questions, etc.) accompanying the request and may use this information to access more information stored in external databases (e.g., credit bureau, mortgage records, motor vehicle accident history, etc.) about a potential insurance customer/insurance customer. Server 901 may then compile the customer data and information from the external databases to determine a set of attributes that may be relevant to a determination of an insurance product/plan for the potential insurance customer/insurance customer.

These attributes may include any number of things, including the current residence of the potential customer/customer, number of automobiles owned by the potential customer/customer, value of a home owned by the potential customer/customer, credit score of the potential customer/customer, etc.

Once the attributes of the potential customer/customer are determined, server 901 may access a database (e.g., workstations 1001, etc.) storing data about attributes and insurance coverage details associated with current customers of the entity managing server 901. Then server 901 may determine which of the current customers have attributes that match those of the potential customer/customer being evaluated. Once a selection of similar current customers has been determined, server 901 may present one or more features associated with the insurance products/plans of the matched current customers to the potential customer/customer being evaluated. In some embodiments, server 901 may further refine presented insurance product/plan options by determining a set of trade-off offerings (e.g., those based on various levels of cost, coverage, etc.). One of ordinary skill in the art would understand that server 901 may present any number of insurance products, including those for automobile, home, and life insurance, among other things.

For instance, in presenting features for an automobile insurance policy to a potential customer, server 901 may access a database storing data about attributes and automobile insurance coverage details associated with current customers of the entity managing server 901. In particular, the database may store information related to bodily injury limits, liability, collision, and/or comprehensive coverage associated with automobile insurance policies of current customers. By comparing relevant attributes of the potential customer with those of the current customers, server 901 may determine that a majority (greater than 50 percent) and/or plurality of current customers whose attributes are similar to the potential customer have automobile insurance products that have certain features. Server 901 may then proceed to present an automobile insurance policy option that has these features (e.g., a predetermined bodily injury limit (e.g., $20,000), liability ($10,000), collision ($10,000), and/or comprehensive ($15,000) coverage). In some aspects, the presented features may represent a range of values rather than a discrete value. In addition, server 901 may present a predetermined deductible associated with each of these coverages. In some aspects, server 901 may further output a percentage of current customers have the presented insurance policy feature.

In presenting trade-off insurance product/plan options, server 901 may analyze the information in the customer database, and determine that while a majority and/or plurality of current customers have an insurance product with a first set of features, a smaller percentage have similar insurance products with other sets of features. In this scenario, server 901 may present each set of features as a trade-off insurance product. For instance, to extend the above example of an automobile insurance product, server 901 may determine that a plurality of current customers with matched attributes has an automobile insurance policy with a $250 deductible for collision coverage but that a significant minority also has policies with a $500 deductible and a $1000 deductible for the same type of coverage. In this scenario, server 901 may present the three levels of deductibles for collision coverage as a set of trade-off options, perhaps as a way to attract potential customers who desire varying premium levels for their automobile collision coverage.

In certain aspects, server 901 may ask one or more questions of a potential customer/customer in determining various attributes of the potential customer/customer. One or more of these questions may relate to general identifying information about the potential customer/customer, including those related to the name, address, social security number, and driver's license number of the potential customer/customer. Other questions may relate to behavioral trade-off preferences (e.g., a desired premium level, a desired coverage level, level of risk tolerance, value of assets needed to be protected, desire for predictable out-of-pocket expenses annually, etc.) that the potential customer/customer may have.

In some aspects, server 901 may present an initial set of insurance policy features based on general identifying information from a potential customer/customer and related information in internal/external databases (e.g., to be used in determining which insurance policy features a select group of current customers of the entity managing server 901 may prefer). Then server 901 may give the potential customer/customer an option to customize/optimize the initial set of insurance policy features. If the potential customer/customer decides to accept an option to customize the initial insurance presentation, server 901 may then ask the potential customer/customer questions related to behavioral trade-off preferences. Server 901 may use answers to the trade-off questions to generate various trade-off insurance policy feature options, including those based on different cost/coverage levels. In certain aspects, server 901 may dynamically (e.g., in real-time) generate a price quote for a presented insurance policy option as the potential customer/customer answers one or more questions or provides more information. In other aspects, the number and/or type of trade-off questions asked may depend on the level of customization that a potential customer/customer may prefer. In other words, the potential customer/customer may decide that all, none, and/or only a subset of the available questions are answered to reach a desired presentation of insurance options. In this way, when no trade-off scenario questions are asked, server 901 may present insurance feature options based on data-driven factors (e.g., customer identifiable information, internal data, external data, etc.). In addition, when trade-off scenario questions are asked, server 901 may present insurance feature options based on a customer-driven trade-off scenario answers.

In the above example of a potential customer seeking an automobile insurance policy, server 901 may present trade-off options based both on what a group (a majority or minority) of current customers prefers and on the potential customer's answers to any of the trade-off questions. For instance, suppose that different groups within a current set of customers with matched attributes to the potential customer prefer an automobile insurance policy with high coverage (high cost plan), medium coverage (medium cost plan), and low coverage (low cost plan). Suppose also that a plurality of current customers prefer the low cost plan, followed by the medium cost plan and the high cost plan. Based solely on the general identifying information of the potential customer and information in external/internal databases matched to related information of current customers, with no trade-off questions, server 901 may present the low cost plan to the potential customer (because the most number of current customers prefer this plan). However, suppose that the potential customer indicates a preference for a high coverage plan in spite of the associated cost in one of answers to a trade-off question. In this scenario, server 901 may present the high cost plan as a first preference, with the medium and low cost plans presented as trade-off options. As such, server 901 may use both general customer information and more customized customer responses to present options with features for an insurance policy.

In some aspects, the insurance product/plan selection process implemented by server 901 may be an adaptive selection process that “learns” over time as customer data sets increase. In this aspect, the selection process may present more and more accurate insurance policy options as the data sets evolve and increase to become more statistically significant. In particular, as the selection process “learns” over time, server 901 may build various profiles or personas to help in presenting insurance options for customers with a predetermined set of attributes. In another aspect, questions asked by server 901 may dynamically change over time as the server 901 recognizes correlations between answers to certain questions and the associated profitability of insurance products presented to customers giving the answers and/or the associated return to the customers themselves giving the answers. In other words, the adaptive selection process discussed herein may allow for refinement of this process by presenting those products/services that have previously been selected most often. In some aspects, prior to presenting an insurance option, server 901 may consider the acceptance rate of a presented insurance product, the availability of new data that may be relevant to a presented insurance product, and any alternative solutions/options that have not yet been presented.

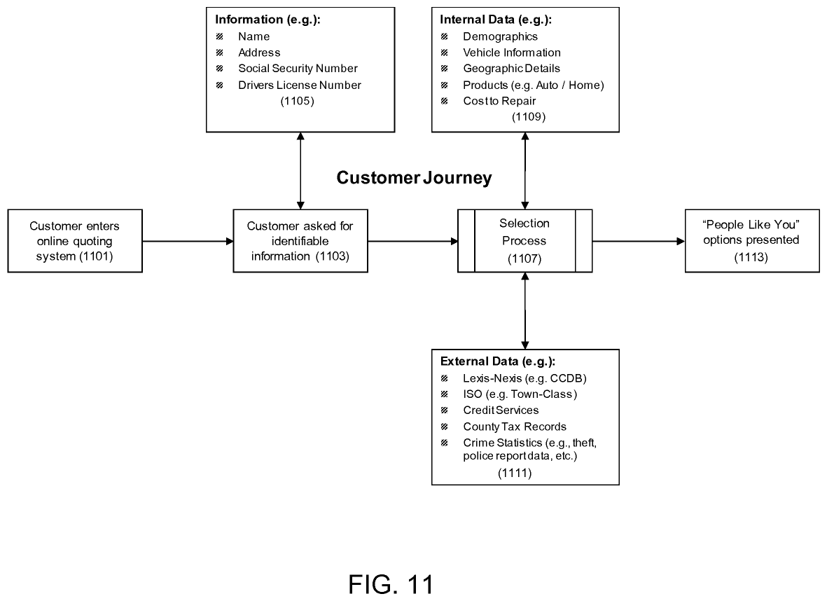

FIG. 11 is a flow chart showing the steps of a data-driven selection process implemented by an enhanced attributes analysis server 901, in accordance with at least one embodiment of the invention. The process in FIG. 11 may start out at step 1101 where a potential customer/customer of an entity (e.g., an insurance company) managing enhanced attributes analysis server 901 may enter into (e.g., login, etc.) an online quoting system of the entity. One of ordinary skill in the art would recognize that while the embodiment shown in FIG. 11 uses an online interface into the enhanced attributes analysis server 901, other communication methodologies (e.g., telephone, short message service (SMS), postal mail, etc.) may be used as well.

The process in FIG. 11 may then move to step 1103 where server 901 may query the potential customer/customer for identifiable information such as name, address, social security number, driver's license number, etc. as shown in box 1105. Then the process may move to step 1107, where server 901 may run a selection process for presenting various features for an insurance policy. In running the selection process, server 901 may first attempt to supplement the customer information obtained in box 1105 with data from internal sources 1109 and external sources 1111.

For instance, internal databases 1109 associated with the entity managing server 901 may include information related to demographics of where the potential customer/customer lives, the vehicle owned by the potential customer/customer, geographic details of where the potential customer/customer lives, insurance products already purchased by the potential customer (e.g., auto and/or home insurance, etc.), and the cost to repair previously damaged insured items owned by the potential customer/customer. Meanwhile, external databases 1111 associated with the entity managing server 901 may include the Lexis-Nexis databases (e.g., Current Carrier Database (CCDB), etc.), Insurance Services Office (ISO) databases (e.g., Town-Class, etc.), credit services databases, county tax records databases, and/or crime statistics databases (e.g., theft, police report data, etc.). Also, the internal and external databases 1109 and 1111 may store information related to the age of the potential customer/customer, gender of the potential customer/customer, marital status of the potential customer/customer, number of years that the potential customer/customer has been driving, zip code where the potential customer/customer lives, global positioning system (GPS) code where the potential customer/customer lives, city/state where the potential customer/customer lives, area code where the potential customer/customer lives, time zone where the potential customer/customer lives, designated market area (e.g., as indicated by Nielson Media Research definitions, etc.) associated with the potential customer/customer, metropolitan statistical area (e.g., as indicated by the Census, etc.) associated with the potential customer/customer, number of uninsured and/or underinsured drivers in the zip code where the potential customer/customer lives, type of vehicle that the potential customer/customer drives, type of home that the potential customer/customer insures, and/or number of years that the potential customer/customer has been with a prior insurance carrier.

In addition, internal and external databases 1109 and 1111 may store information related to urban and/or rural factors related to where the potential customer/customer lives, weather factors related to where the potential customer/customer lives, model year of the vehicle driven by the potential customer/customer, category (e.g., sports utility vehicle, sedan, etc.) of the vehicle driven by the potential customer/customer, list price of the vehicle driven by the potential customer/customer, ownership (e.g., own, lease, etc.) of the vehicle driven by the potential customer/customer, usage (e.g., work, pleasure, school, etc.) of the vehicle driven by the potential customer/customer, whether or not the household of the potential customer/customer owns multiple vehicles, whether or not there is a student driver in the household of the potential customer/customer, whether anyone in the household of the potential customer/customer rents or owns a vehicle, the credit score of the potential customer/customer, the driving record of the potential customer/customer, and the propensity of someone like the potential customer/customer to bundle/have multiple insurance products.

In some embodiments, server 901 may weigh one or more pieces of information as being more important than other pieces of information in presenting insurance options. Also, in some aspects one or more pieces of information may not be included at all in the selection process. For instance, in one example, the age of a potential customer/customer, address of the potential customer/customer, and value of a home owned by the potential customer/customer may be the only attributes that are considered by server 901 in presenting insurance options. Meanwhile, in another example, the number of years that the potential customer/customer has been with a prior insurance carrier and the number of years that the potential customer/customer has been driving may be the only attributes considered by server 901 in presenting insurance options. Moreover, in this second example, server 901 may weight the number of years with a prior insurance carrier as less important than the number of years that the potential customer/customer has been driving. In yet other embodiments, the weightings for each of the attributes may change as server 901 encounters larger datasets.

Once all relevant attributes of the potential customer/customer are determined from various sources 1105, 1109, and 1111, server 901 may access a database including information related to attributes of current customers of the entity managing server 901 and their associated insurance policies. Once accessed, server 901 may match some or all of the attributes of the potential customer/customer to the attributes of a subset of the current customers in the database. After a matching set of current customers is found, server 901 may use one or more features of the insurance policies preferred by current customers in presenting insurance options to the potential customer/customer. Server 901 may present these insurance options as “people like you” options, (e.g., displayed as insurance options preferred by people with similar attributes to the potential customer/customer) as shown in step 1113. In some aspects, server 901 may present various aspects of the insurance options on a display screen associated with a user terminal that the potential customer/customer may be using.

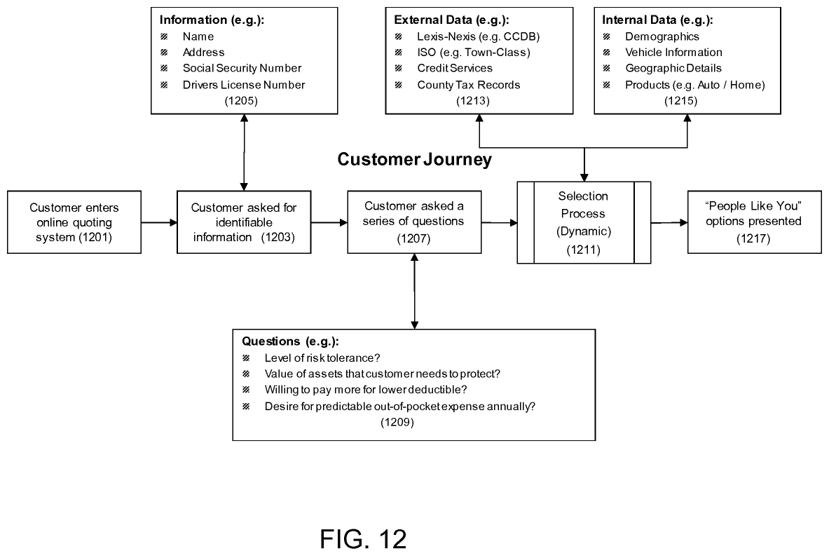

FIG. 12 is a flow chart showing the steps of a customer-driven trade-off selection process implemented by an enhanced attributes analysis server 901, in accordance with at least one embodiment of the invention. Similar to the process shown in FIG. 11, the process in FIG. 12 may start out at step 1201 where a potential customer/customer of an entity (e.g., an insurance company) managing enhanced attributes analysis server 901 may enter into (e.g., login, etc.) an online quoting system of the entity. One of ordinary skill in the art would recognize that while the embodiment shown in FIG. 12 uses an online interface into the enhanced attributes analysis server 901, other communication methodologies (e.g., telephone, short message service (SMS), postal mail, etc.) may be used as well.

The process in FIG. 12 may then move to step 1203 where server 901 may query the potential customer/customer for identifiable information such as name, address, social security number, driver's license number, etc. as shown in box 1205. Then the process may move to step 1207, where server 901 may query the potential customer/customer with one or more questions 1209 related to the generation of trade-off scenarios. For instance, these questions 1209 may relate to the level of risk tolerated by the potential customer/customer (e.g., customer does/does not worry about catastrophic events occurring, etc.), the value of assets that the potential customer/customer may need to protect (e.g., insurable versus non-insurable assets, etc.), the willingness of the potential customer/customer to pay more money for a lower deductible, the stability of a potential customer's/customer's personal and profession situation (e.g., does the potential customer/customer foresee his/her personal/professional situation changing within a predetermined time period?, etc.), and/or the desire for a predictable out-of-pocket expense annually (e.g., self-insurability, etc.), among other things.

Then the process may move to step 1211, where server 901 may run a dynamic selection process for presenting various features for an insurance policy. In running the selection process, server 901 may first attempt to supplement the customer information obtained in box 1205 and 1209 with data from internal sources 1215 and external sources 1213, as mentioned for FIG. 11.

Once all relevant attributes of the potential customer/customer are determined from various sources 1205, 1209, 1213, and 1215, server 901 may access a database including information related to attributes of current customers of the entity managing server 901 and their associated insurance policies. Once accessed, server 901 may match some or all of the attributes of the potential customer/customer to the attributes of a subset of the current customers in the database. After a matching set of current customers is found, server 901 may use one or more features of the insurance policies preferred by current customers as insurance options presented to the potential customer/customer. Again, server 901 may present these insurance options as “people like you” options (e.g., displayed as insurance options preferred by people with similar attributes to the potential customer/customer) as shown in step 1217.

In some aspects, server 901 may present various aspects of the insurance options on a display screen associated with a user terminal that the potential customer/customer may be using. In presenting insurance options, server 901 may display various trade-off scenarios based on the level of coverage and/or cost preferred by the potential customer/customer, as detailed in the answers to the trade-off questions 1209. The potential customer/customer may be given the option to answer any number of trade-off questions. In other words, the potential customer/customer may choose the level of customization achieved by the options presented by server 901. The selection process 1211 may dynamically present various insurance product features by taking into account both the preferences of current customers who share attributes with the potential customer/customer and the specific answers given by the potential customer/customer to the trade-off scenario questions.

In other aspects, the selection process shown in FIGS. 11 and 12 may also be used by the entity managing server 901 to present ancillary services or generate partnerships with third-party entities (e.g., car maintenance services, extended warranty services, security services, financial planning services, asset preservation services, etc.). An example of a way in which the entity managing server 901 may present ancillary services may encompass a situation in which a potential customer/customer requests home insurance for a home that public records show does not have an alarm system. If the home is located in a place that is at higher risk for theft, crime, etc., the entity managing server 901 (e.g., an insurance company) may present options for discounted installation and monitoring of a home security system in partnership with a home alarm services company, in addition to the presentation of home insurance options. In this way, the entity managing server 901 may present options for complementary products/services that may not be manufactured by the entity itself.

In some aspects, this platform may help to convey a sense of confidence and reassurance to a potential customer/customer that an insurance product they will be purchasing is the right choice and that no other information is necessary to validate the purchase. Also, server 901 may present meaningful options to keep potential consumers/consumers engaged (e.g., by creating momentum, etc.) so that they obtain an insurance quote quicker. In addition to presenting options for an insurance product/plan, server 901 may also facilitate customer reviews of presented insurance products/plans, insight into whether or not the reviews were helpful, other ratings, and sales ranks. In one aspect, web analytics tags (e.g., JavaScript computer code) may be used to generate data on the performance of presented insurance options.

Also, this functionality may allow server 901 to help potential customers/customers bundle various insurance features, products, and/or plans by presenting insurance options based on what similar customers have preferred. For instance, when a potential customer/customer makes a request for automobile insurance, server 901 may present not only options for automobile insurance but also for other types of insurance, including homeowner's insurance, life insurance, etc.

The functionality behind server 901 may be integrated into a web server, mobile device, social media platform (e.g., Facebook®, etc.), and other tools for insurance agents/representatives. Software applications running on hardware devices supporting the functionality of server 901 may use Extensible Markup Language (XML), among other file types.

In some aspects, server 901 may include an interactive simulator to help potential customers/customers understand and choose the best coverage for a given situation. A “coverage illustrator” that is a part of server 901 may help to show how coverages may work in different situations. The output from the “coverage illustrator” may be used in conjunction with situational, demographic, geographic, or vehicle information to present interactive, customized insurance options.

In addition, the hardware platform supporting the functionality of server 901 may also consider other attributes associated with a potential customer/customer in presenting insurance options, including an analysis of the most frequent types of insurance claims filed in the area that the potential customer/customer lives, an analysis of particularly hazardous driving spots such as dangerous intersections within the area, a listing of cars reported stolen within the area, and an analysis of weather-related coverages in the area.

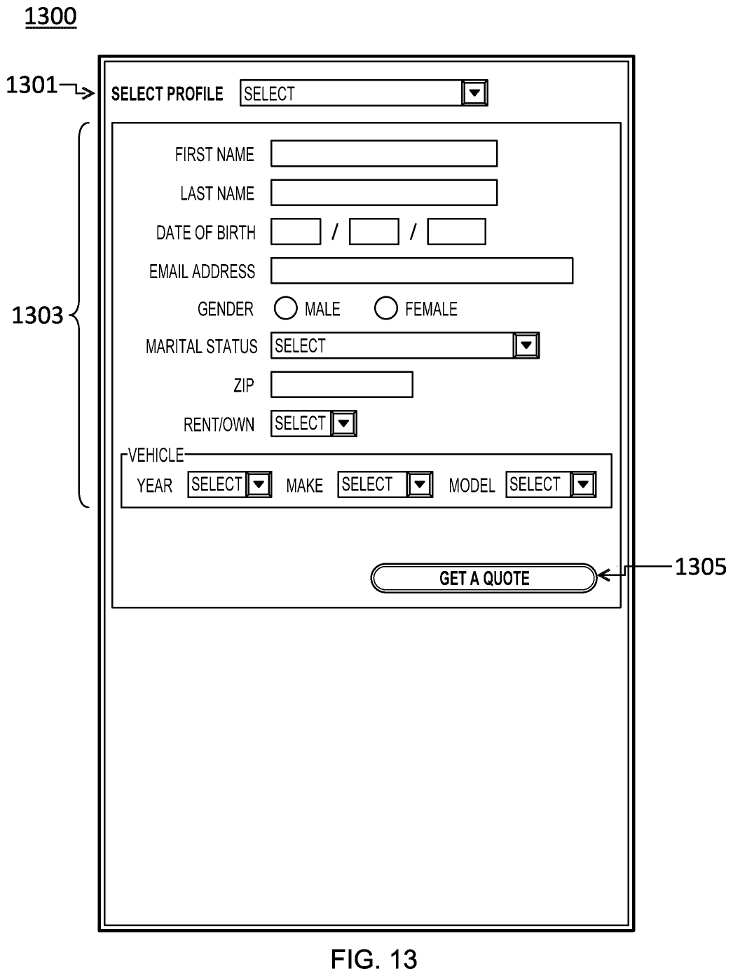

FIGS. 13-15 show various illustrations of user interface screens for interacting with server 901, in accordance with at least one embodiment of the invention. These screens may be presented on display screens associated with user terminals (e.g., workstations 1001) in communication with server 901. In particular, FIG. 13 shows a first user interface screen 1300 for inputting information used by server 901 in presenting insurance options (e.g., a quick insurance quote, etc.) to a potential customer/customer of an entity (e.g., an insurance company) managing server 901, in accordance with at least one embodiment of the invention. Screen 1300 includes various sections that ask a user (e.g., potential customer/customer, insurance agent, etc.), to enter customer information, including a profile name 1301 and other customer-identifying information 1303. The profile name 1301 may refer to a high-level name that groups a potential customer/customer into a category with other potential customers/customers. In one embodiment, the profile name 1301 may be chosen based on predetermined attributes of the potential customer/customer, including age, homeownership status, and/or automobile make/model. Other customer-identifying information 1303 may include the first name, last name, date of birth, email address, gender, marital status, and zip code of the potential customer/customer. Information 1303 may also include an indicator of whether the potential customer/customer rents or owns a vehicle/home and the year, make, and model of the vehicle owned by the potential customer/customer. In some aspects, information 1303 may also include a mailing address and phone number of the potential customer/customer. In addition, screen 1300 includes a button 1305 for allowing a user to obtain insurance package options based on the information entered in sections 1301 and 1303.

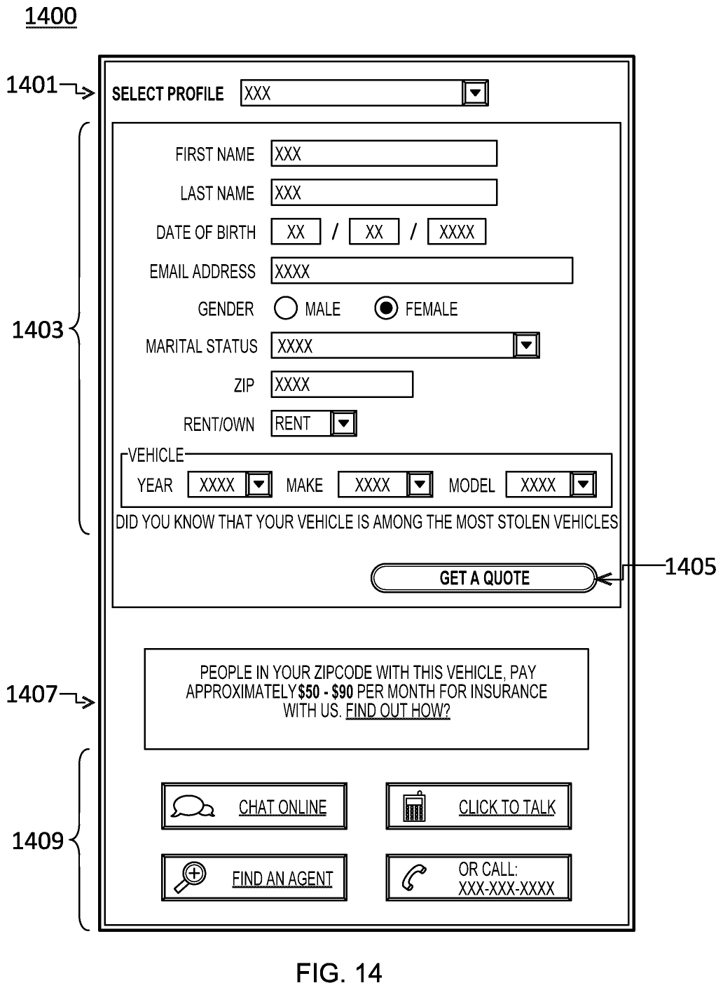

FIG. 14 shows a second user interface screen 1400 for inputting information used by server 901 in presenting insurance options to a potential customer/customer of an entity (e.g., an insurance company) managing server 901, in accordance with at least one embodiment of the invention. Screen 1400 is similar to screen 1300; however, screen 1400 also includes an example profile name 1401 and sample customer-identifying information 1403. After inputting information into sections 1401 and 1403 of screen 1400, a user has pushed button 1405, causing server 901 to generate an insurance quote 1407. In this case, quote 1407 includes a statement about the approximate monthly premiums paid by people within the same zip code as the potential customer/customer. One of ordinary skill in the art would recognize that any number of other attributes may be used to match current customers of the entity managing server 901 with the potential customer/customer.

In addition, screen 1400 also includes various options 1409 which allow a user to obtain additional information about the insurance quote 1407, including an option to chat online, talk to a representative, find an agent, or call a specific phone number.

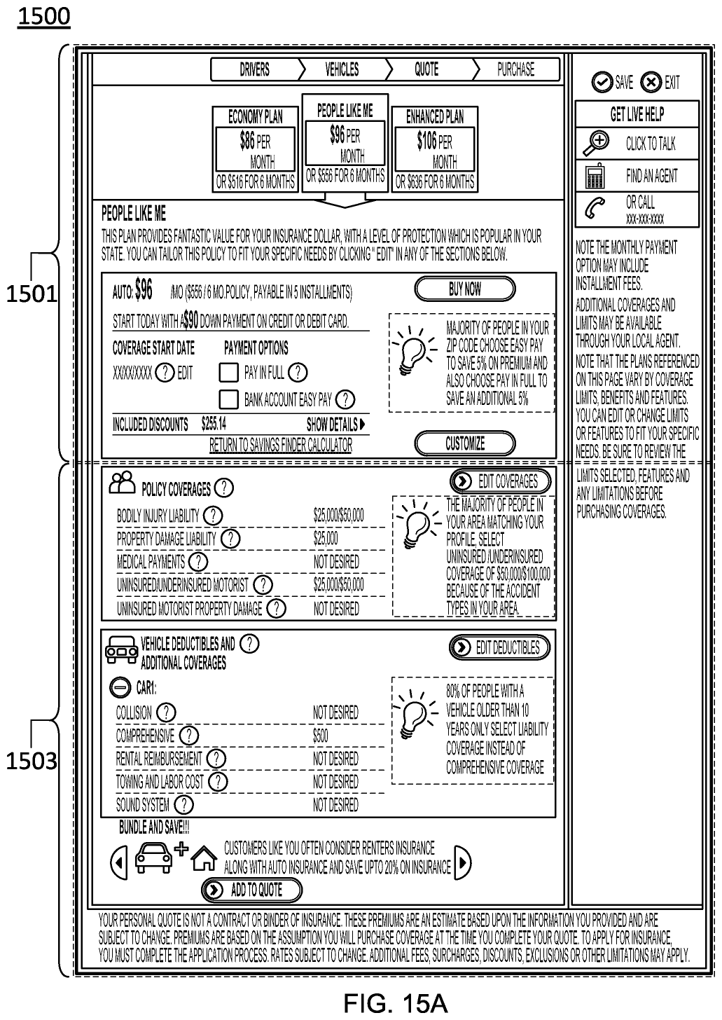

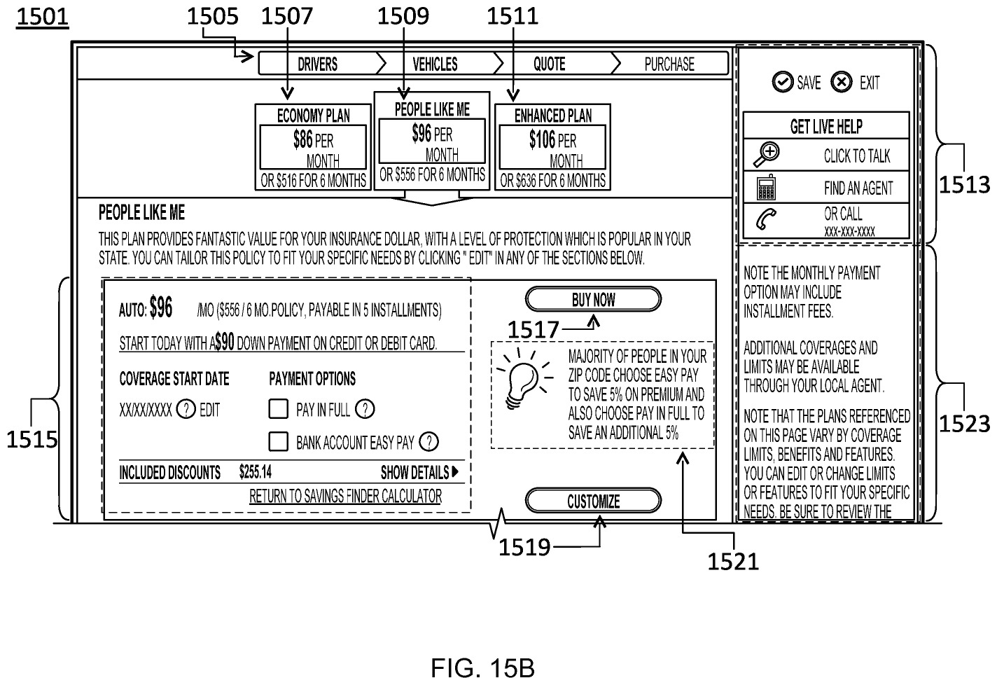

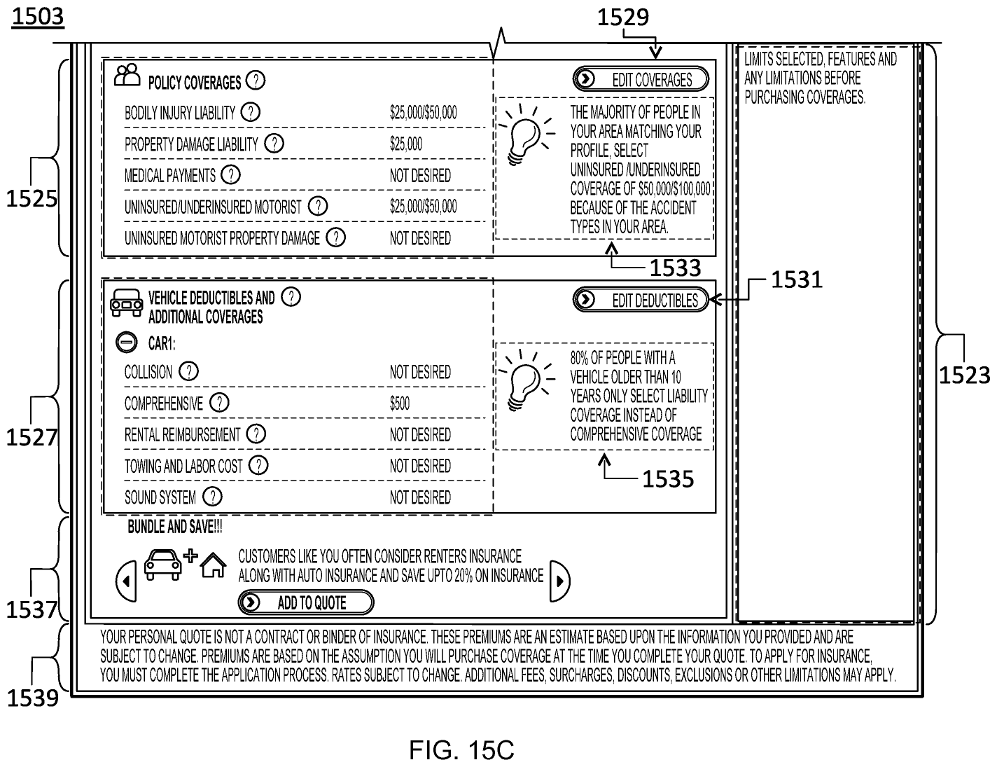

FIG. 15a shows a third user interface screen 1500 depicting a detailed insurance option based on information entered in screens 1300 and/or 1400, in accordance with at least one embodiment of the invention. For clarity, screen 1500 has been divided into an upper section 1501 and a lower section 1503. FIG. 15b shows a detailed view of upper section 1501 of screen 1500, in accordance with at least one embodiment of the invention. Upper section 1501 of screen 1500 includes a menu 1505 that may allow a user to navigate from entering information about a potential customer/customer and/or his/her insurable assets (e.g., vehicles, etc.) to generating a quote and purchasing a presented insurance product/plan option.

Section 1501 also presents options generated by server 901 for three automobile insurance plans based on customer information entered in, for example, screens 1300 and/or 1400 and information accessed through internal/external databases. The options presented by server 901 include an economy plan 1507, a “people like me” plan 1509, and an enhanced plan 1511. The three plans may be seen as trade-off options based on varying levels of cost and coverage. For instance, the “people like me” plan 1509 may represent the automobile insurance plan that is most commonly purchased by current customers that have similar attributes to the potential customer/customer seeking a new insurance plan. Meanwhile, the economy plan 1505 may represent a less expensive plan preferred by matched current customers that are particularly sensitive to cost and the enhanced plan 1511 may represent a more expensive plan preferred by matched current customers that are particularly interested in enhanced coverage.

Upper section 1501 of screen 1500 may also include section 1513 where a user may save the information on screen 1500, exit from screen 1500, and/or obtain additional information about the insurance product/plan presented, including an option to talk to a representative, find an agent, or call a specific phone number. The upper section 1501 of screen 1500 may also include a section 1515 that may further describe details of the insurance product/plan options presented by server 901. In this case, section 1515 includes details of the “people like me” option 1509, including details about the coverage start date, payment options, and included discounts. Section 1501 also includes buttons 1517 and 1519 to either buy a presented insurance product/plan or further customize the presented product/plan. In addition, helpful tips 1521 may be strategically placed throughout screen 1500. Finally, upper section 1501 of screen 1500 may also include a notes section 1523 that may describe further details on the presented plan, including a date that the plan was presented, fees associated with the insurance quote, and other disclaimers.

FIG. 15c shows a detailed view of lower section 1503 of screen 1500, in accordance with at least one embodiment of the invention. Lower section 1503 of screen 1500 may include a section 1525 that further describes coverages associated with the presented insurance policy and a section 1527 that further describes deductibles and/or additional coverages associated with the presented insurance policy. For instance, section 1525 includes details about coverages associated with an automobile insurance option, including details about bodily injury liability coverage, property damage liability coverage, medical payment coverage, uninsured/underinsured motorist coverage, and/or uninsured motorist property damage coverage. In addition, section 1527 incudes details about deductibles and/or additional coverages associated with the automobile insurance option, including details about collision coverage, comprehensive coverage, rental reimbursement coverage, towing and labor cost coverage, and sound system coverage.

Lower section 1503 of screen 1500 may also include buttons 1529 and/or 1531 to edit the presented coverages/deductibles. Also, as mentioned earlier, helpful tips 1533 and 1535 may be placed strategically throughout screen 1500. In addition, notes section 1523 from FIG. 15b may also extend into FIG. 15c.

Lower section 1503 of screen 1500 may include a section 1537 that includes details about options for bundling the presented insurance product/plan with other insurance products/plans to realize additional savings. Finally, section 1503 may include a disclaimer section 1539 for additional disclaimers about the insurance options presented.

The foregoing descriptions of the invention have been presented for purposes of illustration and description. They are not exhaustive and do not limit the invention to the precise form disclosed. Modifications and variations are possible in light of the above teachings or may be acquired from practicing of the invention. For example, the described implementation includes software but the present invention may be implemented as a combination of hardware and software or in hardware alone. Additionally, although aspects of the present invention are described as being stored in memory, one skilled in the art will appreciate that these aspects can also be stored on other types of computer-readable media, such as secondary storage devices, like hard disks, floppy disks, or CD-ROM; a carrier wave from the Internet or other propagation medium; or other forms of RAM or ROM. The scope of the invention is defined by the claims and their equivalents.

Other embodiments of the invention will be apparent to those skilled in the art from consideration of the specification and practice of the invention disclosed herein. The specification and examples should be considered as exemplary only, with a true scope and spirit of the invention being indicated by the following claims.

1. A method comprising:
receiving identifying data from an insurance consumer at a server;
using a processor, determining a first plurality of attributes of the insurance consumer based on the identifying data;
retrieving, from at least one database, a plurality of customers associated with a second plurality of attributes and a plurality of insurance features, wherein at least one of the first plurality of attributes matches with at least one of the second plurality of attributes;
using a processor, determining a first plurality of features, of the plurality of insurance features, preferred by a first subset of the plurality of customers and a second plurality of features, of the plurality of insurance features, preferred by a second subset of the plurality of customers; and
using a processor, presenting tradeoff insurance options comprising at least one of the first plurality of features and at least one of the second plurality of features.
